(19) United States
(12) Patent Application Publication
(10) Pub. No.: US 2007/0240247 A1
(43) Pub. Date: Oct. 18, 2007

(54) Antimicrobial protective hand device

(76) Inventor: Emily A Beck, Wilmington, DE (US)

Correspondence Address: EMILY A BECK, 108 HAYWOOD ROAD, WILMINGTON, DE, 19807, US

(21) Appl. No.: 11/714,620

(22) Filed: Mar. 6, 2007

Related U.S. Application Data
(60) Provisional application No. 60/779,964, filed on Mar. 7, 2006.

(51) Int. Cl. A41D 13/08; A01N 25/34

(52) U.S. Cl. 2/16; 424/402; 424/404

(57) ABSTRACT

An antimicrobial, absorbent and wicking, stretch protective hand device with grip enhancing properties.

### CROSS REFERENCE TO RELATED APPLICATION

This application is based on provisional application 60/779964, filed Mar. 7, 2006.

### FIELD OF INVENTION

This invention relates to a protective glove for use public areas with antimicrobial and/or antiviral, moisture absorbing and wicking, breathable, ventilating, slip-resistant, and grip-enhancing properties.

### BACKGROUND OF INVENTION

Public areas, such as subways, buses, trains, shopping malls, grocery stores, gas stations and rest rooms, frequently require physical interaction with objects including poles, handles, knobs, and doors that many people touch with bare hands. Anyone coming into contact with these objects exposes herself or himself to the body oils and fluids, germs and bacteria, left by other people.

Protective, disposable gloves exist specifically for medical use and food preparation with antimicrobial properties, and gloves for athletic and industrial work purposes have slip-resistant properties to achieve firm gripping ability for rigorous work. Disposable gloves tend to be uncomfortable and hot with no allowance for moisture absorption nor air circulation, and the bulk of athletic and work gloves reduce tactile sensitivity and are unsuitable for hand protection during every day, routine activities. For example:

U.S. Pat. No. 6,560,782 to Hourihan et al. (2003) shows an antimicrobial glove made of a single layer or multiple layers of latex or rubber for long term household, or janitorial use, having an antimicrobial agent to prevent malodor, degradation of the glove, and growth of bacteria that can occur from moisture from hands.

U.S. Pat. No. 5,725,867 to Mixon (1998) shows a glove for use during food preparation, made of a plastisol material, such as PVC, or other polymer, with antimicrobial agent Triclosan.

U.S. Pat. No. 5,146,628 to Hermann et al. (1992) shows an industrial work glove with a slip-resistant polyurethane coating, applied in beads and adhered to the outer surface, rendering the glove abrasion and cut-resistant. The beads of the coating are approximately 1/32 inch high and 1/16 inch wide, the coating being partially absorbed into the fabric.

U.S. Pat. No. 6,912,731 to Cass (2005) shows a non-slip glove for all types of weather in which emory cloth is employed as an exterior and interior friction material on the inside and outside of at least three finger stalls. A plurality of relief holes on the underside of palm and fingers expose areas of skin to provide sensory perception of object being handled.

U.S. Pat. No. 5,511,248 to Widdemer (1996) shows a sports glove, particularly a golf glove, with an anti-slip thermoplastic film panel that can be separately added to the glove, or made an integral part of the glove over the palm and/or fingers.

### BACKGROUND OF INVENTION—OBJECTS AND ADVANTAGES

As evident from the foregoing examples, no glove before this has been designed and manufactured specifically to protect hands during utilization of public areas and public transportation, provide the comfort and usability of lightweight, breathable, and stretch fabric with antimicrobial properties that absorbs moisture and wicks it into the atmosphere, has palm and finger applications with anti-slip and anti-microbial properties, is thin enough for easy storage, and is washable and reusable.

### SUMMARY

The antimicrobial, protective hand device, a well fitting, durable, and washable glove made of a substantially elastic single layer of uncoated fabric that breathes, absorbs and wicks moisture away from the skin, and keeps hands dry and cool. The antimicrobial and/or antiviral agent, either woven into the fabric, or topically applied, or both, tends to inhibit growth of bacteria, fungi, and mildew. Unlike the former inventions' full panel, additional layer, or laminated sheets to achieve slip-resistance, the present invention's slip resistant, grip-enhancing, and stretchable polymer based discreet units or decals comprise a minimal portion of the glove designed not to interfere with the overall stretchiness, breathability and wicking action of the fabric. Units, or decals, are strategically placed on fingers and/or palm of the glove to facilitate common daily activities including, but not limited to, use in public transportation and other public utility areas, cell phone use, and credit card handling. Decals may also include an antimicrobial and/or antiviral agent. Ventilation and comfort is achieved, and bulkiness is reduced, by a cut out portion of the glove, exposing bare skin of the palm and/or fingers.

### DRAWINGS

FIG. 1 is the back portion of a glove, showing a ventilation cut out.

FIG. 2 is the palm portion of a glove on which adhered decals are shown.

FIG. 3 is a cross section of the inner surface and outer surface of wicking material

FIG. 4 is a cross section of two layered materials.

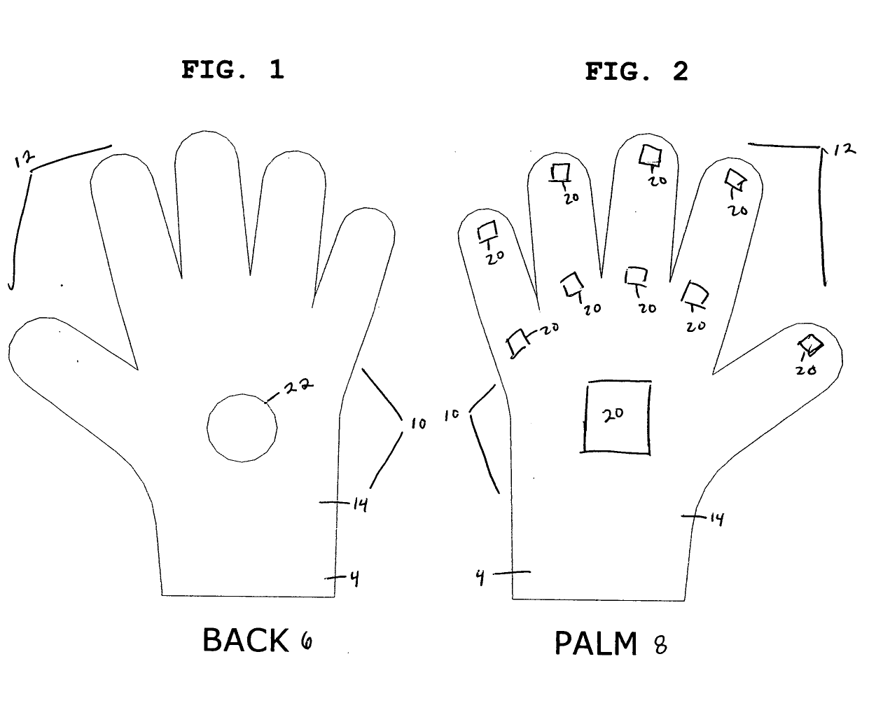

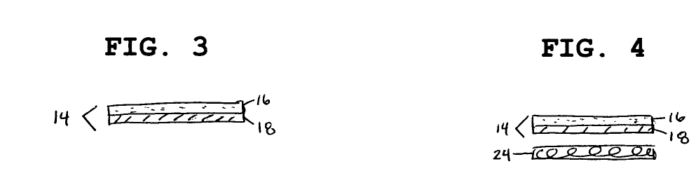

### DRAWINGS—REFERENCE NUMERALS

4 glove
6 entire back portion of glove
8 entire palm portion of glove
10 palm area
12 finger area
14 wicking material
16 inner surface of wicking material
18 outer surface of wicking material
20 decals
22 cut outs
24 multi layered materials

### DETAILED DESCRIPTION

An example of the uncoated, wicking material 14, may comprise a material which transports body fluids from the inner surface 16 through capillary action and/or geometric action carrying fluid to its outer surface 18, dispersing fluid throughout the fabric 14 for evaporation. For example, fluid directed toward the outer surface 18 of this wicking material 14 allows the inner surface 16 to remain substantially dry—in this way the fluid is wicked from the inner surface 16 to the outer surface 18. Suitable wicking materials 14 include single layer or multi-layered materials.

Fabric 14 may comprise polyester, nylon, cotton and/or a spandex or Lycra. Material 14 may also be nonwoven or woven, or made of synthetic, or natural fibers. Fabric 14 may comprise a cotton polyester blend ranging from 3-5 oz/sq yd, or a polyester spandex blend ranging from 3-8 oz/sq yd.

Decals 20, such as heat transfers, are adhered to material 14 by a heat process, and preferably comprise a polymer, plastisol, or rubber material. Decals 20 are substantially elastic, to stretch similarly with the stretch material 14 onto which they are adhered. In one application, decals 20 can cover less than 50% of the palm area 10 or the finger area 12. In other applications, the decals 20 cover less than 25% of the palm area 10 or the finger area 12.

The glove 4 is preferably manufactured by traditional stitching.

In addition to taking form of a glove 4, it may also take form of a mitten, which could include a singe compartment finger portion or could include a thumb portion and a compartment for the remaining fingers.

Ventilation may be further achieved by cut-outs 22 on the back portion 6 or finger area 12. Cut-outs 22 may also be located on palm area 10 of the palm portion 8. However, glove 4 may be manufactured without a cut-out 22 entirely.

### DETAILED DESCRIPTION CONT.

The glove 4 may further comprise additional materials 24 and/or composite structures 24 to protect hands from inclement weather and/or to provide warmth. The glove 4 may further comprise multiple layers of insulating, wicking, or other performance or comfort-enhancing materials 24.

The glove 4 may be manufactured using alternative methods, including but not limited to, ultrasonics, radiofrequency, or another type of adhesion such as seam tape.

Decals 20 may include a material such as a polymer, plastisol, or rubber, such as ink used in a silk screening process, ink of which is substantially inelastic. Decals 20 could also be sewn onto material 14 without a heat process.

What is claimed is:

1. A protective hand device in the form of a glove having a palm portion and a back portion, said palm portion comprising a palm and finger area, and said glove being made of a material which is antimicrobial and absorbent and has wicking properties.

2. The device of claim 1 wherein said palm portion includes at least one decal made of slip resistant material.

3. The device of claim 2 wherein said decal is elastic.

4. The device of claim 2 wherein said decal includes an antimicrobial agent.

5. The device of claim 3 wherein said decal is provided on palm area of said palm portion.

6. The device of claim 5 wherein said decal is provided on said finger area.

7. The device of claim 3 wherein said decal is provided on said finger area.

8. The device of claim 6 wherein said glove is in the form of a fingered glove, said finger area includes five digits.

9. The device of claim 8 wherein said decals are provided on each of said digits.

10. The device of claim 9 wherein a plurality of said decals are provided on each of said digits.

11. The device of claim 6 wherein said glove is in the form of a mitten.

12. The device of claim 6 wherein said back portion includes a cut out.

13. The device of claim 1 wherein said glove is made of a material which is elastic and lightly absorbent.

14. The device of claim 13 wherein said material is a single layer of uncoated fabric.

15. The device of claim 14 wherein an antimicrobial and/or antiviral agent is woven into the fabric of said material.

16. The device of claim 14 wherein an antimicrobial and/or antiviral agent is topically applied to the fabric of said material.

17. The device of claim 14 including at least one decal is mounted to each of said palm and finger area, and said decal being made of a slip resistant elastic material.

18. The device of claim 17 wherein said decals cover less than 50% of the total area of said palm portion.

19. The device of claim 13 wherein said material is a multilayered material.

20. The device of claim 13 including ventilation cutouts in the palm portion.
